(19) United States
(12) Patent Application Publication
(10) Pub. No.: US 2003/0153280 A1
(43) Pub. Date: Aug. 14, 2003

(54) Handset having a retractable keypad

(76) Inventors: Joe Kopp, Redwood City, CA (US); Peter Fornell, Lake Oswego, OR (US); Gadi Amit, Belmont, CA (US); Joshua T. Morenstein, San Francisco, CA (US); Christopher Lenart, San Francisco, CA (US); Jacques Gagne, Los Gatos, CA (US); Dore Mark, San Francisco, CA (US); Ray Gradwohl, Saratoga, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/071,588

(22) Filed: Feb. 8, 2002

(51) Int. Cl. H04M 1/00

(52) U.S. Cl. 455/90; 455/575; 455/566

(57) ABSTRACT

A wireless handheld device having a retractable keypad is provided according to an embodiment of the present invention. The device comprises a housing having an opening and a display coupled to the housing. A keypad is coupled to the housing open. A spring mechanism is coupled to the housing and the keypad, and extends the keypad from the housing open. The keypad and a microphone are positioned in a keypad housing having a first opening and an end for closing the device housing opening. A zigzag spring is positioned in the device housing and the keypad housing for extending the keypad responsive to pressing a button. A first member is coupled to a second member for guiding the keypad housing. The first member has a lock surface and the keypad housing has a lock surface for engaging with the first member lock surface responsive to the keypad housing being inserted into the device housing.

### FIELD OF THE INVENTION

This invention relates generally to a wireless handheld device.

### BACKGROUND OF THE INVENTION

A wireless handheld device or handset, such as a cellular telephone or Personal Digital Assistant (“PDA”), is used to access information locally or remotely as well as communicate with others. Handsets include internal electronic components, such as a processor and memory, and also a user interface for inputting and outputting information. Most handsets have a display for outputting information such as text, graphics or video. Likewise, most handsets have an input mechanism, such as a keypad or a microphone for inputting information.

Users often desire very small handsets that are easily carried. Yet, users also desire user interfaces that are easy to use and are not prone to input errors. Often, users want a large display and large keypad for conveniently inputting information, but at the same time want a small, easily portable handset.

Manufacturers and handset designers also must decide where to position internal electronic components in order to enhance communication performance, manufacturability and handset reliability.

Therefore, it is desirable to provide a relatively small, portable handset that also has a user interface that is easy to use and not prone to input errors. Further, the handset should enhance communication performance, allow for efficient manufacturing and increased reliability.

### SUMMARY OF THE INVENTION

A wireless handheld device having a retractable keypad is provided according to an embodiment of the present invention. The device comprises a housing having an opening and a display coupled to the housing. A keypad is coupled to the housing open. A spring mechanism is coupled to the housing and the keypad, and extends the keypad from the housing open.

According to an embodiment of the present invention, the device includes a transceiver for generating and receiving a short-range radio signal in a short distance wireless network.

According to an embodiment of the present invention, the transceiver includes a 2.1 GHz transceiver, a 2.4 GHz transceiver, or a 5.7 GHz transceiver.

According to an embodiment of the present invention, the device includes a transceiver for generating and receiving cellular signals in a Wide Area Network (“WAN”).

According to an embodiment of the present invention, the cellular signals are generated with a cellular protocol selected from the group consisting of a Code Division Multiple Access (“CDMA”), CDMA 2000, Universal Mobile Telecommunications System (“UMTS”), Time Division Multiple Access (“TDMA”), and General Packet Radio Service (“GPRS”) protocol.

According to an embodiment of the present invention, the short distance wireless network is selected from the group consisting of Bluetooth™ network, 802.11 network, and HomeRF network.

According to an embodiment of the present invention, the keypad is positioned on a first surface of a keypad housing having a first opening and an end for closing the housing opening.

According to an embodiment of the present invention, the spring mechanism includes a zigzag spring positioned in the device housing and the keypad housing for extending the keypad.

According to an embodiment of the present invention, the spring mechanism further includes a first member coupled to a second member for guiding the keypad housing.

According to an embodiment of the present invention, the first member has a lock surface and the keypad housing has a lock surface for engaging with the first member lock surface responsive to the keypad housing being inserted into the device housing.

According to an embodiment of the present invention, the spring mechanism further comprises a button coupled to the housing. A cam surface is coupled to the button. The cam surface moves the first member responsive to an insertion of the button such that the keypad housing extends from the device housing.

According to an embodiment of the present invention, the first member has a second lock surface for engaging the keypad housing lock surface such that the keypad housing is stopped from extending from the device housing.

According to an embodiment of the present invention, the keypad housing includes a flexible printed circuit board (“PCB”) coupled to the device housing.

According to an embodiment of the present invention, the keypad housing includes a microphone coupled to the device housing.

According to still a further embodiment of the present invention, a wireless handheld device comprises a housing having a first end and an opening at a second end. A first transmitter is coupled to the housing and generates a short-range radio signal in a short distance wireless network. A second transmitter is coupled to the housing and generates a cellular signal. A display is coupled to the housing at the first end. A processor is coupled to the display and positioned at the first end of the housing. A memory is coupled to the processor and positioned at the first end of the housing. A keypad is coupled to a keypad housing and positioned into the housing opening. A button is coupled to the housing and extends the keypad housing responsive to pressing the button.

Other aspects and advantages of the present invention can be seen upon review of the figures, the detailed description, and the claims that follow.

### BRIEF DESCRIPTION OF THE FIGURES

FIGS. 1a-b illustrate a front and rear view of a device having a retractable keypad according to an embodiment of the present invention.

FIGS. 2a-c illustrate a front and rear view of a device having a retractable keypad according to an embodiment of the present invention.

FIG. 3 illustrates an internal partial view of a device having a compressed spring according to an embodiment of the present invention.

FIG. 4 illustrates an internal view of a device having an extended spring according to an embodiment of the present invention.

FIG. 5 illustrates a partial side view of a keypad and microphone housing according to an embodiment of the present invention.

FIG. 6 illustrates an inserted keypad housing having a guide according to an embodiment of the present invention.

FIG. 7 illustrates an extended keypad housing having a guide according to an embodiment of the present invention.

FIGS. 8a-b illustrate a device having a flexible PCB according to an embodiment of the present invention.

FIG. 9 is hardware block diagram of a device according to an embodiment of the present invention.

FIG. 10 illustrates a software block diagram of a device according to an embodiment of the present invention.

FIG. 11 illustrates a system having a device according to an embodiment of the present invention.

### DETAILED DESCRIPTION

I. Retractable Keypad Handset

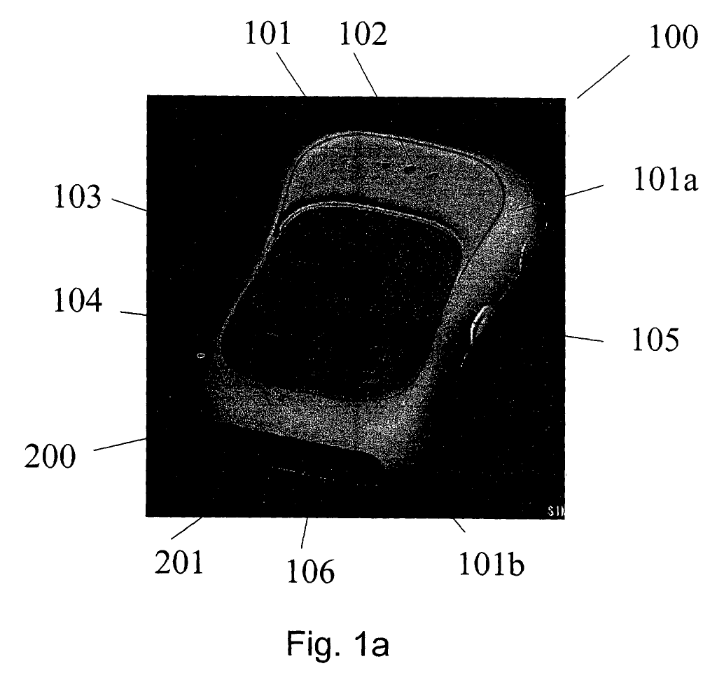

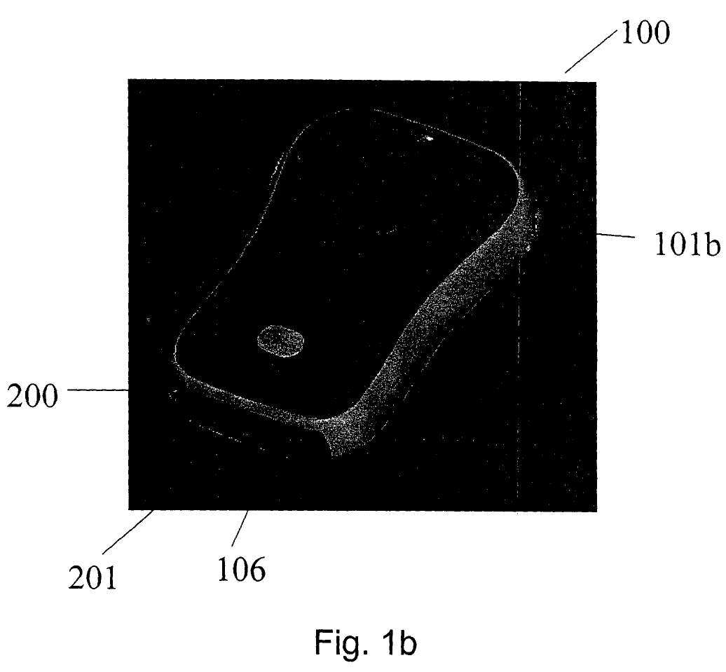

FIG. 1a illustrates a front view of a handheld wireless device 100 according to an embodiment of the present invention. Device 100 includes a device housing 101 having a front half housing 101a coupled to a rear half housing 101b by mechanical fasteners, and in particular interlocking snaps. In an embodiment of the present invention, housing 101 is made of lightweight high impact Acrylonitrile-Butadiene-Styrene (“ABS”) and/or polycarbonate plastic. Display 103 is coupled to front half housing 101a. Buttons 104 are used for inputting user information or commands that are input frequently. For example, a buttons 104 include a button for answering or terminating a telephone call or a button for browsing or dialing a telephone number stored in memory in an embodiment of the present invention. In still a further embodiment of the present invention, buttons 104 include a button for scrolling up information displayed on display 103 in an embodiment of the present invention. Buttons 104 are horizontally separated by at least three button widths in order to allow a user to easily input information or commands without erroneously pressing the wrong button in an embodiment of the present invention. This spacing between buttons 104 is available on front half housing 101a because device keypad 107 having keypad buttons are extendable from housing 101 by a user as described below. Further, a larger portion of housing 101a is available to position display 103 because keypad 107 is inserted and retractable from housing 101. Display 103 is positioned on up to 50% of the upper surface of front half housing 101a. Accordingly, a user is able to view more information on a compact easily portable handset.

Keypad extending button 105 is used to extend keypad housing 106 from housing 101, and in particular, from housing opening 200. A user can push keypad housing 106 back into housing 101, where keypad housing 106 is locked, when a user does not need to use keypad 107. This extractable keypad 106 allows a user the flexibility of having a relatively small handset device and still has a keypad that is available when needed by the user.

Speaker 102 is used to output audio signals while microphone 201 is used for inputting audio signals, such as a user's voice. Microphone 201 is operational in either of the keypads position.

FIG. 1b illustrates a rear view of device 100. Keypad housing 106 is inserted in device housing opening 200 according to an embodiment of the present invention.

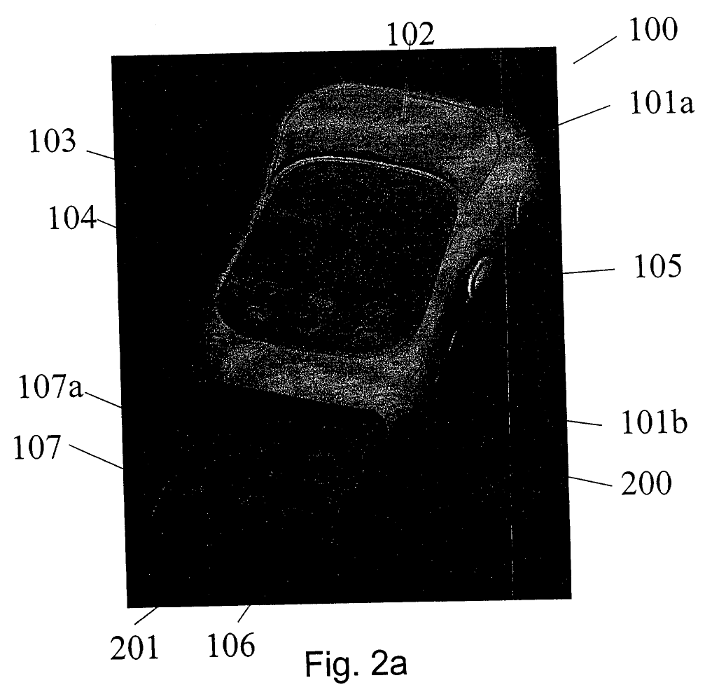

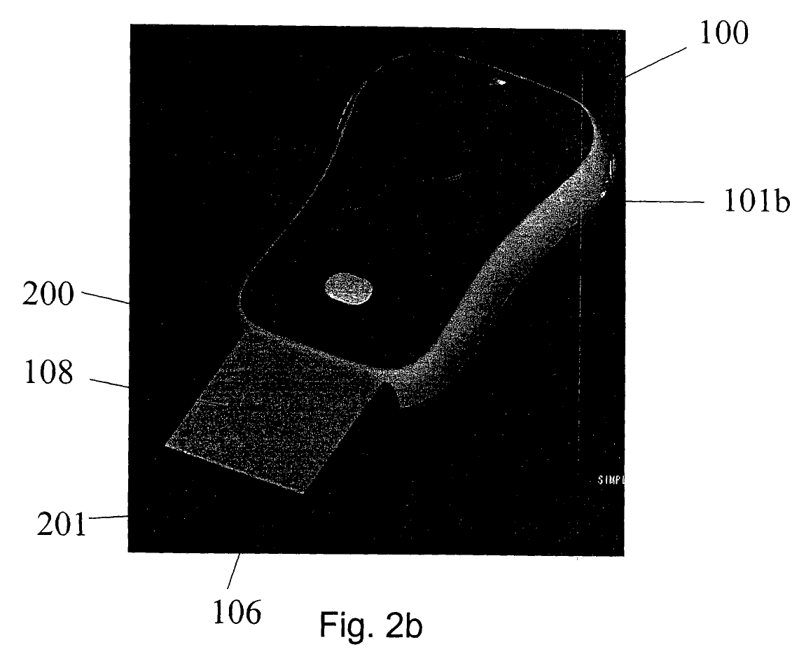

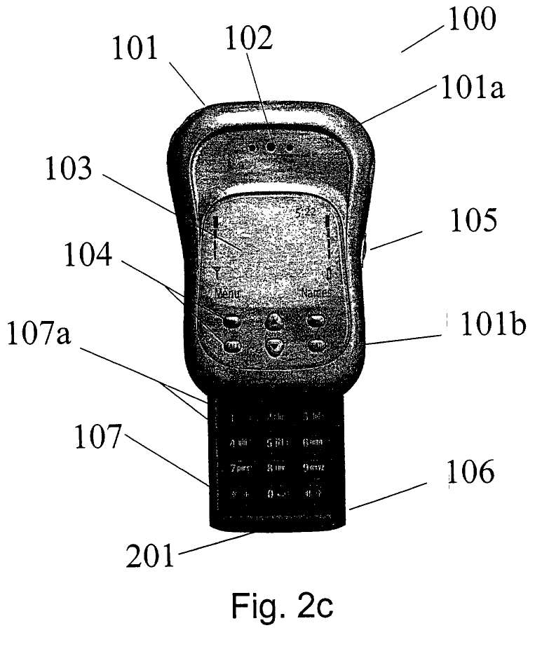

FIGS. 2a and c illustrate a front view of extending keypad housing 106, and in particular keypad 107, from device housing 101 responsive to a user pressing keypad extending button 105 according to an embodiment of the present invention. FIG. 2b illustrates a rear view of extending keypad housing 106 from device housing 101 responsive to a user pressing keypad extending button 105.

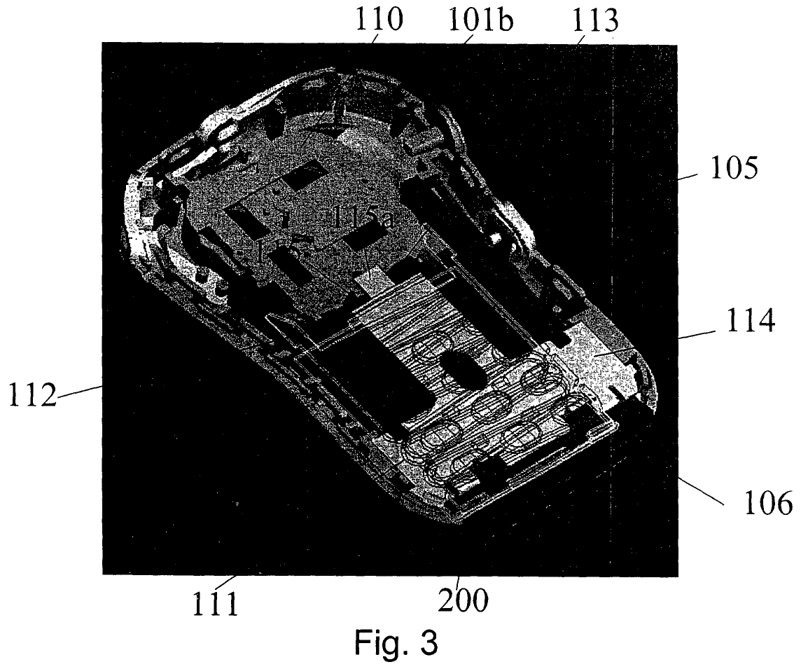

FIG. 3 illustrates an internal partial view of a device 100 having a compressed spring 111 according to an embodiment of the present invention. Device 100 includes a rear half housing 101b that includes an opening 110 and 200. Opening 110 is used to position electronic components, such as a processor and memory, in the top end of device 100. Opening 200 is used for positioning keypad housing 106.

A number of benefits are achieved in positioning the electronic components in opening 110. Concentrating most of the electronic components in opening 110 enables easier manufacturing. A single or few modules are positioned in opening 110 rather than throughout device 100. Further, if electronic components are positioned throughout device 100 rather than concentrated in opening 110, electronic components may be more susceptible to impedance mismatch due to relatively long wire connections between electronic components as well as more susceptible to wear and failed circuitry.

An additional powering saving benefit is achieved in an embodiment of the present invention. Keypad 107 is backlit only when keypad housing 106 is extended, as illustrated in FIG. 2a, in an embodiment of the present invention. When keypad 107 is not needed and thus keypad housing 106 is retracted, as illustrated by FIG. 1a, keypad 107 is not backlit and power is saved.

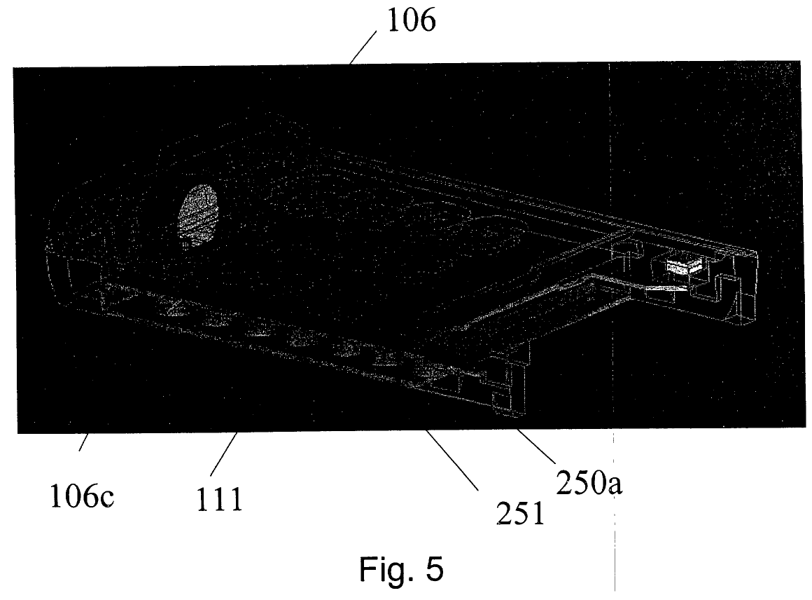

Keypad housing 106 is positioned in opening 200 at the bottom of device housing 101. Keypad housing 106 has an opening 270, as illustrated in FIG. 5, for positioning compressed spring 111. In an embodiment of the present invention, spring 111 is a zigzag spring. In alternate embodiment of the present invention, different types of springs are used, such as a compression or torsion spring.

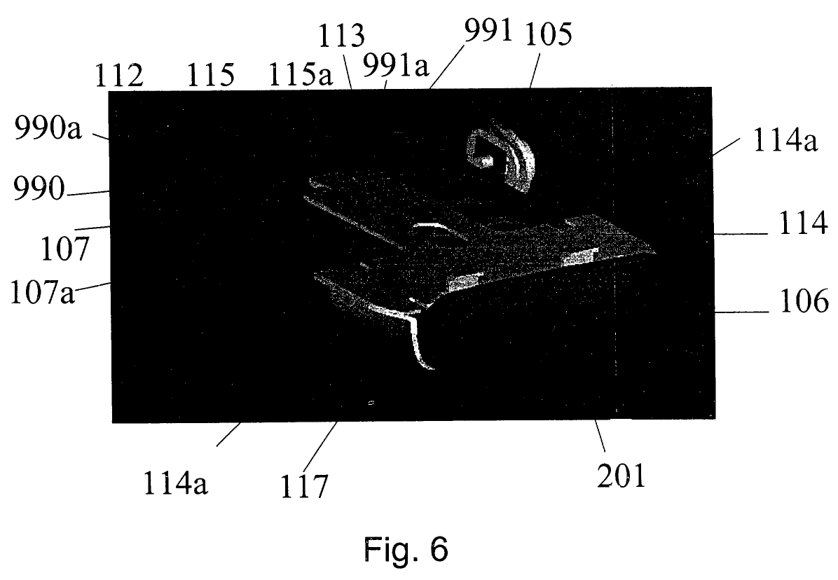

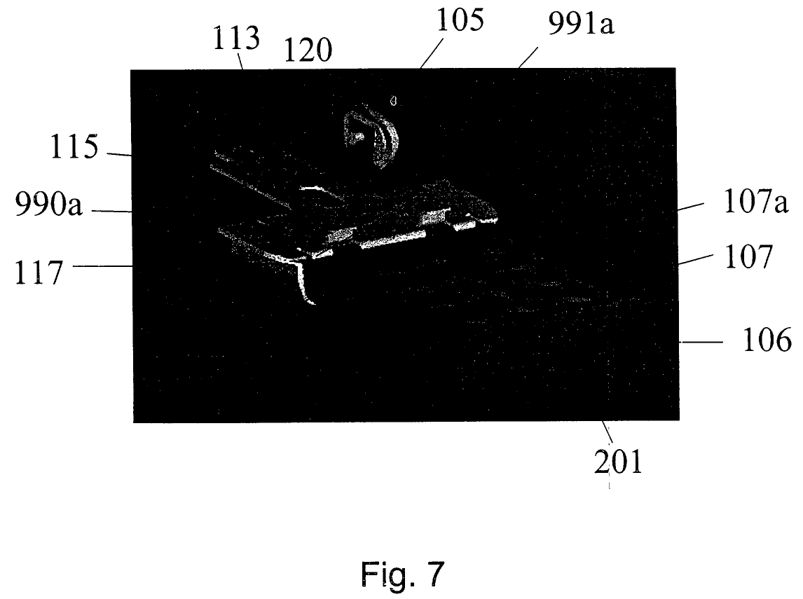

Members 114 and 117 guide keypad housing 106 in and out of device housing 101, as illustrated in FIGS. 6 and 7. In an embodiment of the present invention, members 114 and 117 are sheet metal members connected to form a sleeve around keypad housing 106. Member 114 includes a lock surface 115 that engages edge or lock surface 112 of keypad housing 106 when keypad housing 106 is inserted into device housing 101 as illustrated in FIGS. 3 and 6. Member 114, and in particular member portion 700, also supports spring 111 when keypad housing 106 is extended. Member portion 700 also ensures that when keypad housing 106 begins to be pushed back into housing 101, spring 111 can not buckle and disengage. Thus, spring 111 stays on track and continues to compress properly.

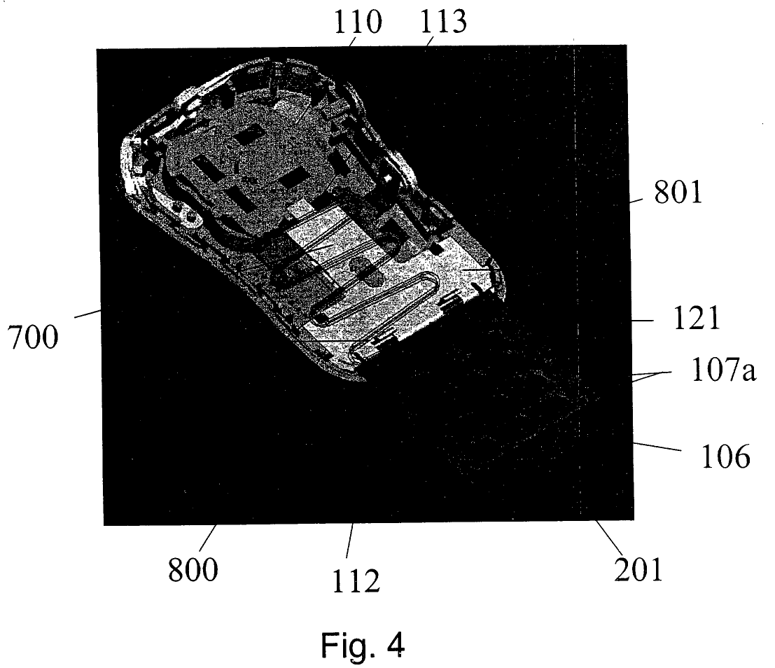

Keypad housing 106 is extended, as illustrated in FIGS. 4, 7 and 8, when a user depresses keypad extending button 105. Cam surface 113 is coupled to keypad button 105, via connection 120 and raises member 114, and in particular tab 115a. Member lock surface 115 disengages from keypad housing lock surface 112 allowing spring 111 to decompress and thus extend keypad housing 106. Keypad housing 106 is stopped from extending by stop surface 121 of member 114 engaging with edge or lock surface 112 of keypad housing 106. After keypad housing 106 extends, keypad buttons 107a are then available for user input.

Arms 990 and 991 are support members for keypad housing 106. When keypad housing 106 extends, arms 990 and 991 accomplish several functions. First, arms 990 and 991 support keypad housing 106 from vertical (up, down) and lateral (left, right) forces inside members 114 and 117. Second, arms 990 and 991 provide additional stopping action of the spring extension at surface 990a and 991a with member 114, as seen in FIG. 7. Third, arms 990 and 991 provide additional left/right guide support for spring 111. Fourth, magnet 992, as illustrated in FIG. 5, allows for electrical actuation of a hall effect switch that initiates several software commands and recognizes when keypad housing 106 is retracted or extended. This actuation, a) turns on/off backlighting for easy use in low light situations; b) answers/hangs up incoming or active calls; c) wakes up/sleeps device 100 for power saving.

FIG. 5 illustrates a partial side view of keypad housing 106 according to an embodiment of the present invention. Members 250 and 251, and in particular sheet metal members 250 and 251, positions spring 111 in opening 270 of keypad housing 106 in an embodiment of the present invention. Sheet metal members 250 and 251 is a single sheet metal piece, member 250, bent in a “U” shape in an embodiment of the present invention. In still a further embodiment of the present invention, sheet metal 251 is used as bottom 108 of keypad housing 106, as illustrated in FIG. 2b. Keypad 107 having buttons 107a are positioned on a top surface of keypad housing 106. Bottom keypad housing 106a is formed to fit flush with the bottom of device housing 101.

Member 250, as illustrated in FIG. 5, is inserted into keypad housing 106 by a self-locking mechanism. First, fingers of member 250 are inserted into holes of keypad housing 106 in the area shown as 106c. Then, member 250 is rotated down and snaps into keypad housing 106 by spring arms 250a and 250b. This locking assembly ensures that there is consistent space for spring 111 and it is not squeezed, preventing spring 111 form working properly.

FIG. 6 illustrates a partial view of inserted keypad housing 106 having a guide according to an embodiment of the present invention. In an embodiment, members 114 and 117 are sheet metal. Members 114 and 117 form a sleeve around keypad housing 106 and guide keypad housing 106 during insertion or retraction to housing 101 and during extension from housing 101.

Members 114 and 117 are coupled to housing 101. Member 117 is inserted into housing 101 and then member 114 is placed on top of member 117. Members 114 and 117 are locked into housing 101 by snaps 800 and 801 illustrated in FIG. 4. These snaps are anti-spreading, since the harder a force is applied to keypad housing 106, the tighter the snaps hold members 114 and 117 in place. In an alternate embodiment of the present invention, members 114 and 117 are tack welded together in area 114a.

FIG. 7 illustrates an extended keypad housing 106 having a guide, and in particular members 114 and 117. As described above, stop surface 121 of member 114 stops keypad housing 106 from further extension by engaging edge or lock surface 112 of keypad housing 106. In an embodiment of the present invention, bending the end of sheet metal member 114 forms surface 112.

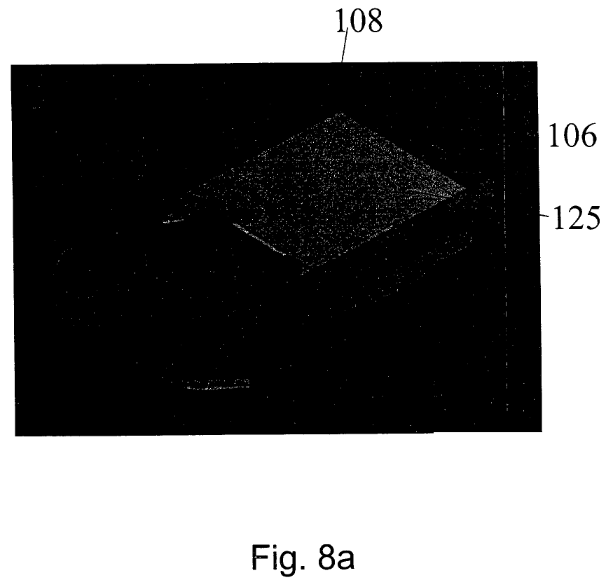

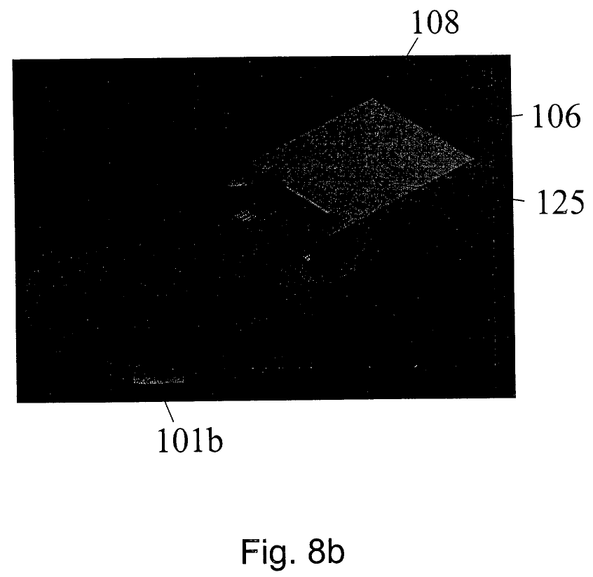

FIG. 8a illustrates a flexible Printed Circuit Board (“PCB”) 125 that is hot barred coupled to keypad housing 106 and rear half housing 101b. PCB 125 is folded over itself creating a loop as illustrated in FIG. 8a. In particular, legs 125a and 125b of PCB 125 are coupled to the inner surface of housing 101b. Legs 125a and 125b include traces for carrying signals between keypad 107 and microphone 201 and internal electronic components in opening 110. Thus, when housing keypad 106 is extended as illustrated in FIG. 8b, flexible PCB enables an electrical connection between keypad buttons 107a and other electronic components positioned in opening 110.

II. Handset Electronic Components

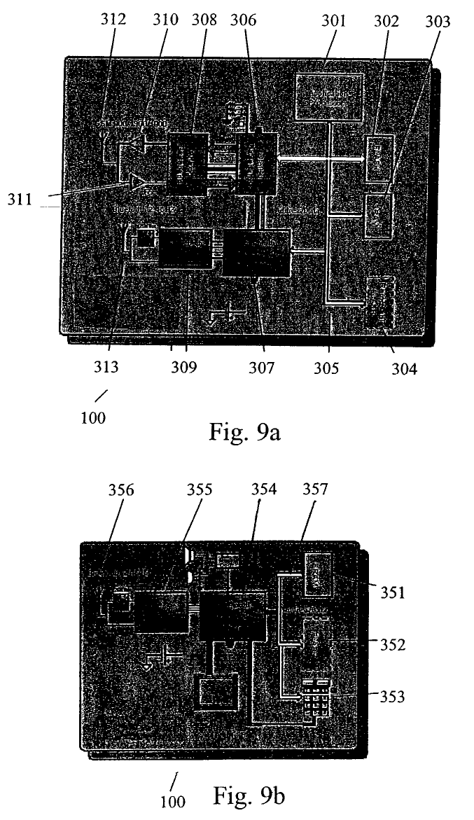

FIG. 9a illustrates a hardware block diagram of electronic components for handheld wireless device 100 in an embodiment of the present invention. In an embodiment of the present invention, device 100 includes both internal and removable memory. In particular, device 100 includes internal FLASH (or Electrically Erasable Programmable Read-Only Memory (“EEPROM”)) and static Random Access Memory (“SRAM”) 302 and 303, respectively. Removable FLASH memory 304 is also used in an embodiment of the present invention. Memories 302, 303, and 304 are coupled to bus 305. In an embodiment of the present invention, bus 305 is an address and data bus. Application processor 301 is likewise coupled to bus 305. In an embodiment of the present invention, processor 301 is a 32-bit processor.

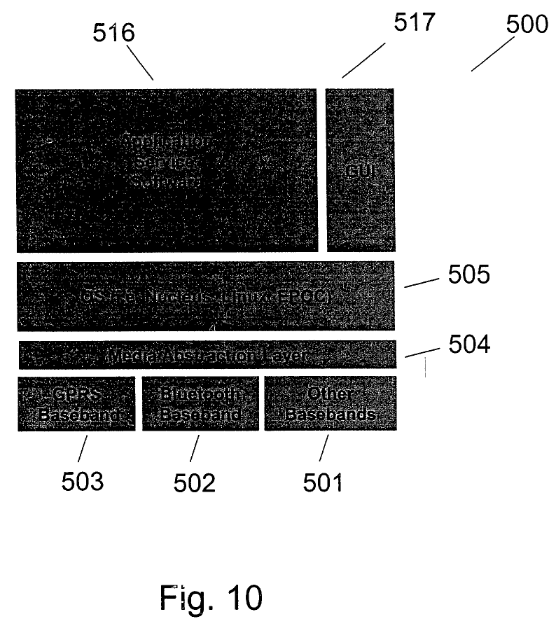

Bluetooth™ processor 307 is also coupled to bus 305. Bluetooth™ RF circuit 309 is coupled to Bluetooth™ processor 307 and antenna 313. Processor 307, RF circuit 309 and antenna 313 transceiver and receive short-range radio signals to and from terminals 107, illustrated in FIG. 10, or device 350, illustrated in FIG. 9b.

Cellular, such as GSM, signals are transmitted and received using digital circuit 306, analog circuit 308, transmitter 310, receiver 311 and antenna 312. Digital circuit 306 is coupled to bus 305. In alternate embodiments, device 100 includes a display, a speaker, a microphone, a keypad and a touchscreen, singly or in combination. In an embodiment of the present invention, keypad 107 is coupled to bus 305 via PCB 125.

FIG. 9b illustrates an alternate embodiment of internal electronic components of device 110 that is a hand-held device in an embodiment of the present invention. Device 100, in an embodiment of the present invention, is one of the terminals 107 illustrated in FIG. 10. Device 100 includes SRAM and FLASH memory 351 and 352, respectively. Memories 351 and 352 are coupled to bus 357. In an embodiment of the present invention, bus 357 is an address and data bus. Keypad 353 is also coupled to bus 357. In an embodiment of the present invention, keypad 353 is keypad 107 and PCB 125 couples keypad 107 to bus 357. Short-range radio signals are transmitted and received using Bluetooth™ processor 354 and Bluetooth™ RF circuit 355. Antenna 356 is coupled to Bluetooth™ RF circuit 355. In an embodiment of the present invention, antenna 356 transmits and receives short-range radio signals. In alternate embodiments, device 100 includes a display, a speaker, a microphone, a keypad and a touchscreen, singly or in combination. As one of ordinary skill in the art would appreciate, other hardware components would be provided for device 100 in alternate embodiments of the present invention.

III. Handset Software

FIG. 10 illustrates software architecture 500 for a device 106 utilizing terminal devices such as device 100 according to an embodiment of the present invention. In an embodiment of the present invention, device 100's graphical user interface 517 is executed on device 106 and not locally on device 100. In an embodiment of the present invention, software 500 is stored in FLASH memory 302 of device 100. In an embodiment of the present invention, device 100 acting as a terminal in terminals 107 includes Bluetooth™ baseband software component 502, media abstraction layer software component 504, operating system software component 505, user interface and other peripheral software component drivers. In an alternate embodiment of the present invention, software components 517 and 516 are stored in FLASH memory 353 in a device 100. In an embodiment of the present invention, software components referenced in FIG. 10 represent a software program, a software object, a software function, a software subroutine, a software method, a software instance, and a code fragment, singly or in combination. In an alternate embodiment, functions performed by software components illustrated in FIG. 10 are carried out completely or partially by hardware.

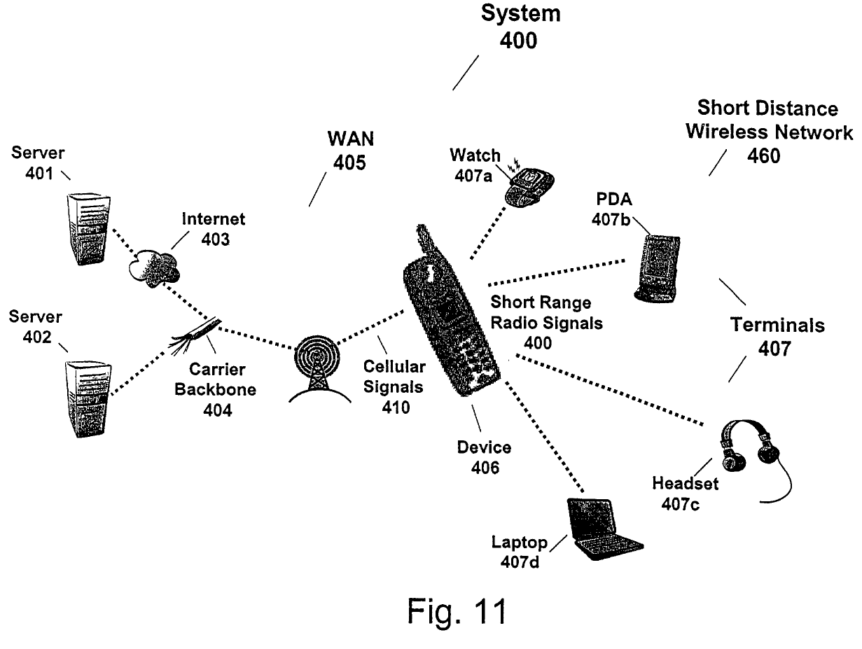

In an embodiment of the present invention, software 500, or components of software 500, is stored in an article of manufacture, such as a computer readable medium. For example, software 500 is stored in a magnetic hard disk, an optical disk, a floppy disk, CD-ROM (Compact Disk Read-Only Memory), RAM (Random Access Memory), ROM (Read-Only Memory), or other readable or writeable data storage technologies, singly or in combination. In yet another embodiment, software 500, or components thereof, is downloaded from server 402 illustrated in FIG. 11.

Software 500 includes telecommunication software or physical layer protocol stacks, in particular cellular communications software 503 and short-range radio communications software 502. In an embodiment, communication software 503 is a GPRS baseband software component used with a processor to transmit and receive cellular signals. In an embodiment, communication software 502 is a Bluetooth™ baseband software component used with a processor to transmit and receive short-range radio signals. Other telecommunication software may be used as illustrated by other basebands 501.

In an embodiment of the present invention, operating system (“OS”) 505 is used to communicate with telecommunications software 502 and 503. In an embodiment of the present invention, operating system 505 is a Linux operating system, EPOC operating system available from Symbian software of London, United Kingdom or a PocketPC or a Stinger operating system available from Microsoft® Corporation of Redmond, Wash. or Nucleus operating system, available from Accelerated Technology, Inc. of Mobile, Ala. Operating system 505 manages hardware and enables execution space for device software components.

Media abstraction layer 504 allows operating system 505 to communicate with basebands 503, 502 and 501, respectively. Media abstraction layer 504 and other abstraction layers, described herein, translate a particular communication protocol, such as GPRS, into a standard command set used by device 100. The purpose of an abstraction layer is to isolate the physical stacks from the rest of the device software components. This enables future usage of different physical stacks without changing any of the upper layer software and allows the device software to work with any communication protocol.

In an embodiment of the present invention, application service software component 516, operating system 505 and Bluetooth™ Baseband software component 502 are used to generate and receive short-range radio signals 110.

Furthermore, Graphics User Interface (“GUI”) 517 is provided to allow a user-friendly interface on display 103.

IV. System

In an embodiment of the present invention, device 100 is included in a short distance wireless network 460, as illustrated by FIG. 11. In an alternate embodiment of the present invention, device 100 includes a transceiver to a Wide Area Network, such as GSM/GPRS, CDMA, UMTS, CDMA200 or equivalent. In an embodiment of the present invention, device 100 is device 106 acting as a gateway between Wide Area Network (“WAN”) and short distance wireless network 460 or a terminal in terminals 407. In an embodiment of the present invention, device 406 and one or more terminals 407 communicate to form a short distance wireless network 460. In an embodiment of the present invention, terminals 407 are coupled to device 406 by short-range radio signals 400 to form short distance wireless network 460. In an embodiment of the present invention, some or all of terminals 407 may have wired connections. In an embodiment of the present invention, terminals 407 include watch 107a, PDA 107b, headset 107c, laptop computer 107d and device 100. In an alternate embodiment, fewer or more terminals are used in short distance wireless network 460. In an alternate embodiment, terminals 407 include a desktop computer, a pager, a printer, a thin terminal, messaging terminal, a digital camera or an equivalent. In an embodiment of the present invention, terminals 407 include a Bluetooth™ 2.4 GHz transceiver. Likewise, device 406 includes a Bluetooth™ 2.4 or 2.1 GHZ transceiver. In an alternate embodiment of the present invention, a Bluetooth™ 5.7 GHz transceiver is used.

In an embodiment of the present invention, a short distance wireless network 460 is a network of processing devices, such as a personal computer or headset, that span a relatively small physical area, wherein at least one device generates and receives a short-range radio signal for communicating with another device in the network. In an embodiment of the present invention, a short-range radio signal can travel between approximately 0 and approximately 1000 feet. An example of a short distance wireless network includes a network of devices formed by Bluetooth™, HomeRF, 802.11 technologies, singly or in combination, or an equivalent. In an embodiment of the present invention, each processing device in a short distance wireless network has its own processing unit that executes a software component stored on the processing device memory, but also may access data and devices on the short distance wireless network. In an embodiment of the present invention, a wire, and in particular an Ethernet, provides communication between two or more processing devices in a short distance wireless network. In an alternate embodiment, electromagnetic signals provide wireless communication between one or more processing devices in a short distance wireless network. In still another embodiment, both wires and electromagnetic signals provide communication between processing devices in a short distance wireless network.

In an embodiment of the present invention, a WAN includes multiple LANs and/or short distance wireless networks connected over a relatively large distance. Telephone lines and electromagnetic signals, singly or in combination, couple the LANs and/or short distance wireless networks in a WAN. In an embodiment of the present invention, WAN 405 includes a cellular network generating and receiving cellular signals 410. In an embodiment of the present invention, a cellular network is defined as a communications system dividing a geographic region into sections called cells. In an analog embodiment of the present invention, the purpose of this division is to make the most use out of a limited number of transmission frequencies. In an analog embodiment of the present invention, each connection, or for example conversation, requires its own dedicated frequency, and the total number of available frequencies is about 1,000. To support more than 1,000 simultaneous conversations, cellular systems allocate a set number of frequencies for each cell. Two cells can use the same frequency for different conversations so long as the cells are not adjacent to each other.

In an embodiment of the present invention, WAN 405 is coupled to device 406. In an embodiment of the present invention, WAN 405 includes a cellular network transmitting and receiving cellular signals 410. In an embodiment of the present invention, cellular signals 410 are transmitted using a protocol, such as a Global System for Mobile communications (“GSM”) protocol. In alternate embodiments, a Code Division Multiple Access (“CDMA”), CDMA 2000, Universal Mobile Telecommunications System (“UMTS”), Time Division Multiple Access (“TDMA”), or General Packet Radio Service (“GPRS”) protocol or an equivalent is used.

In an embodiment of the present invention, WAN 405 includes carrier backbone 404, server 401-402 and Internet 403. In an embodiment of the present invention, IP packets are transferred between the components illustrated in FIG. 11. In alternate embodiments of the present invention, other packet types are transferred between the components illustrated in FIG. 11.

In an embodiment of the present invention, a WAN 405 includes an IP public or private network, such as a corporate secured network using a Virtual Private Network (“VPN”).

In an alternate embodiment of the present invention, device 406 is coupled to a WAN 405 by an Ethernet, Digital Subscriber Line (“DSL”), or cable modem connection, singly or in combination.

In an embodiment of the present invention, device 406 is a cellular handset or telephone. In an alternate embodiment of the present invention, device 406 is a cellular enabled PDA.

In an embodiment of the present invention, WAN 105 is coupled to a wireless carrier internal network or carrier backbone 104. In an embodiment of the present invention, server 402 is coupled to carrier backbone 404. In an alternate embodiment of the present invention, carrier backbone 404 is coupled to Internet 403. Server 401 is coupled to Internet 403. In an embodiment of the present invention, servers 401 and 402 provide information, such as a web site having web pages or application software components, to terminals 407 by way of device 406. In an embodiment of the present invention, terminals 407 share services and communicate by way of device 406.

### V. CONCLUSION

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1) A device, comprising:
(a) a housing having an opening;
(b) a display coupled to the housing;
(c) a keypad coupled to the housing open; and,
(d) a spring mechanism, coupled to the housing and the keypad, for extending the keypad from the housing open.

2) The device of claim 1, wherein the device includes a keypad housing for positioning the keypad and a microphone.

3) The device of claim 1, wherein the device is a handheld device.

4) The device of claim 1, wherein the device includes a transceiver for generating and receiving a short-range radio signal in a short distance wireless network.

5) The device of claim 4, wherein the transceiver includes a 2.4 GHz transmitter.

6) The device of claim 4, wherein the transceiver includes a 5.7 GHz transmitter.

7) The device of claim 4, wherein the device includes a transceiver for generating and receiving cellular signals in a Wide Area Network (“WAN”).

8) The device of claim 7, wherein the cellular signals are generated with a cellular protocol selected from the group consisting of a Code Division Multiple Access (“CDMA”), CDMA 2000, Universal Mobile Telecommunications System (“UMTS”), Time Division Multiple Access (“TDMA”), and General Packet Radio Service (“GPRS”) protocol.

9) The device of claim 4, wherein the short distance wireless network is selected from the group consisting of Bluetooth™ network, 802.11 network, and HomeRF network.

10) The device of claim 1, wherein the keypad is positioned on a first surface of a keypad housing having a first opening and an end for closing the housing opening.

11) The device of claim 10, wherein the spring mechanism includes a spring positioned in the device housing and the keypad housing for extending the keypad.

12) The device of claim 11, wherein the spring is a zigzag spring.

13) The device of claim 11, wherein the spring is a compression spring.

14) The device of claim 11, wherein the spring is a torsion spring.

15) The device of claim 13, wherein the spring mechanism further includes a first member coupled to a second member for guiding the keypad housing.

16) The device of claim 15, wherein the first member has a lock surface and the keypad housing has a lock surface for engaging with the first member lock surface responsive to the keypad housing being inserted into the device housing.

17) The device of claim 16, wherein the spring mechanism further comprises:
(e) a button coupled to the housing;
(f) a cam surface, coupled to the button, for moving the first member responsive to an insertion of the button, wherein the keypad housing extends from the device housing.

18) The device of claim 17, wherein the first member has a second lock surface for engaging the keypad housing lock surface, wherein the keypad housing is stopped from extending from the device housing.

19) The device of claim 10, wherein the keypad housing includes a flexible printed circuit board (“PCB”).

20) The device of claim 19, wherein the printed circuit board is coupled to the device housing.

21) A wireless handheld device, comprising:
(a) a housing having a first end and an opening at a second end;
(b) a first transceiver, coupled to the housing, for generating a short-range radio signal in a short distance wireless network;
(c) a second transceiver, coupled to the housing, for generating a cellular signal;
(d) a display coupled to the housing at the first end;
(e) a processor, coupled to the display, positioned at the first end of the housing;
(f) a memory, coupled to the processor, positioned at the first end of the housing;
(g) a keypad, coupled to a keypad housing, positioned into the housing opening; and,
(h) a microphone, coupled to a keypad housing, positioned into the housing opening; and,
(i) a button, coupled to the housing, for extending the keypad housing responsive to pressing the button.

22) The wireless handheld device of claim 21, wherein the transmitter is a 2.4 GHz transmitter.

23) The wireless handheld device of claim 21, wherein the transmitter is a 5.7 GHz transmitter.

24) The wireless handheld device of claim 21, wherein the cellular signal is generated with a cellular protocol selected from the group consisting of a Code Division Multiple Access (“CDMA”), CDMA 2000, Universal Mobile Telecommunications System (“UMTS”), Time Division Multiple Access (“TDMA”), and General Packet Radio Service (“GPRS”) protocol.

25) The wireless handheld device of claim 21, wherein the short distance wireless network is selected from the group consisting of Bluetooth™ network, 802.11 network, and HomeRF network.

26) The wireless handheld device of claim 21, wherein the keypad is positioned on a first surface of a keypad housing having a first opening and an end for closing the housing opening.

27) The wireless handheld device of claim 26, further comprising:
(i) a spring, positioned in the device housing and the keypad housing, for extending the keypad.

28) The wireless handheld device of claim 27, wherein the spring is a zigzag spring.

29) The wireless handheld device of claim 27, wherein the spring is a compression spring.

30) The wireless handheld device of claim 27, wherein the spring is a torsion spring.

31) The device of claim 27, further comprising:
(j) a first member, coupled to a second member, for guiding the keypad housing.

32) The handheld wireless device of claim 31, wherein the first member has a first lock surface and the keypad housing has a lock surface for engaging with the first member first lock surface responsive to the keypad housing being inserted into the device housing.

33) The handheld wireless device of claim 32, further comprising:
(k) a cam surface, coupled to the button, for moving the first member responsive to an insertion of the button, wherein the keypad housing extends from the device housing.

34) The handheld wireless device of claim 33, wherein the first member has a second lock surface for engaging the keypad housing lock surface, wherein the keypad housing is stopped from extending from the device housing.

35) The handheld wireless device of claim 21, wherein the keypad housing includes a flexible printed circuit board (“PCB”).

36) The handheld wireless device of claim 35, wherein the printed circuit board is coupled to the device housing, the processor and the memory.

37) The handheld wireless device of claim 21, wherein the keypad is lit in response to the keypad housing being extended from the housing opening.

38) The handheld wireless device of claim 21, wherein the device is activated in response to the keypad housing being extended from the housing opening.

39) The handheld wireless device of claim 21, wherein a telephone call is answered in response to the keypad housing being extended from the housing opening.

40) The hand held wireless device of claim 21, wherein a telephone call is terminated in response to the keypad housing being retracted into the housing opening.

41) The hand held wireless device of claim 21, wherein the illumination of the keypad is responsive to the keypad housing being extended or retracted from the housing opening.

42) The hand held wireless device of claim 21, wherein the microphone is placed at the end of the keypad housing, thus being extended with the keypad from the housing opening.

43) The handheld wireless device of claim 21, wherein a hall-effect switch is used to determine if the keypad is in the extended or retracted position.
